(19) United States
(12) Patent Application Publication
(10) Pub. No.: US 2010/0243575 A1
(43) Pub. Date: Sep. 30, 2010

(54) Portable sludge filtration system

(76) Inventor: Charles Jerold Nowling, Highlands, TX (US)

Correspondence Address: THE MATTHEWS FIRM, 2000 BERING DRIVE, SUITE 700, HOUSTON, TX, 77057, US

(21) Appl. No.: 12/383,736

(22) Filed: Mar. 26, 2009

(51) Int. Cl. B01D 21/01; B01D 21/08; B01D 21/32; B01D 21/34

(52) U.S. Cl. 210/709; 210/142; 210/85; 210/94; 210/767; 210/702; 210/104; 210/88

(57) ABSTRACT

A separation apparatus and system for separating a solid-liquid mixture is described herein. A polymer solution, formed from water and one or more polymers, is mixed, then combined with a solid-liquid mixture to flocculate the solid-liquid mixture, which is then flowed into the separation apparatus. A liquid-permeable filtration member is disposed over the floor, one or more exterior walls, and any interior dividing walls, if present, for retaining solid media within the apparatus while permitting liquid to pass. A controllable distribution system having a plurality of individually actuatable inlets oriented to provide the solid-liquid mixture to discrete areas of the apparatus is usable to selectively maximize the efficiency of the separation process. A support structure can be mounted on one or more of the walls to enable visual observation of the separation process. Control means for the inlets can be accessible from the support structure to enable contemporaneous control of the distribution of the solid-liquid mixture responsive to visual observations.

### FIELD

The present invention relates, generally, to apparatuses, methods, and systems for separating liquids from solids, usable for filtration and treatment of sludge and other solid-liquid mixtures.

### BACKGROUND

The term “sludge” is usable to refer to a variety of solid-liquid mixtures, including slurries, emulsions, or any similar mixture, such as sewage, industrial waste, or contaminated mud. A sludge can contain any number of liquid or solid components, and can have any ratio of liquid to solid, though typically, a sludge has somewhat more liquid than solid material contained therein. Due to the inherent properties of solid-liquid mixtures, many difficulties exist relating to their handling, treatment disposal, and analysis.

Environmental regulations require that prior to disposal of a sludge in a landfill, the water content of the sludge be reduced to an acceptable level. Additionally, a solid-liquid mixture containing a significant quantity of liquid is considerably heavier than a mixture from which some or all of the liquid has been removed, causing transport of the mixture to be difficult and cumbersome. Often, freight carriers and other transporters of a sludge, or similar solid-liquid mixture, assess costs based on the weight of the material transported.

To facilitate efficient and less expensive transport and disposal of solid-liquid mixtures, while complying with environmental regulations, various types of liquid-solid separators have been used to remove the liquid components of the mixture from the solid media. Additionally, the separation of solid-liquid mixtures has many noteworthy industrial applications where it is desirable to retain one or more solid or liquid components for treatment, analysis, processing, or use.

Generally, separation of a solid-liquid mixture is accomplished through filtration, using either vacuum drainage or gravitational drainage. Vacuum drainage requires use of an on-site pump to draw liquid through a filter, and typically necessitates use of a filtrate cavity that remains beneath the surface of the liquid throughout the filtering process. The force of the pump draws solid particles, as well as the liquid portion of the mixture, toward the filter, which can cause blockage of the filter, reducing the speed and efficacy of the separation process.

Gravitational drainage involves simply placing a solid-liquid mixture into a container having one or more filters therein and allowing gravity to pull the liquid through the filters while the solid media is retained. The solid-liquid mixture is normally flocculated using one or more suitable polymers prior to filtration, which facilitates the separation of the mixture. Often, a number of polymers are tested against a waste source or other source of the solid-liquid mixture to determine which polymer will be the most effective for flocculating the mixture. Since no vacuum pumping is required for gravitational drainage, it is not necessary to retain the filtrate cavity beneath the liquid level of the sludge. Filters extending throughout the entire height of the container can be used to maximize surface area for the separation process and minimize the potential for blockage of filters.

However, gravitational drainage is an extremely slow process, often requiring multiple days, or weeks, to separate a significant quantity of sludge. Additionally, due to uneven distribution of the sludge within a container, and uneven rates of drainage for differing portions of the sludge, it is common for large quantities of liquid to be retained in certain portions of the container for a significant length of time while other portions of the liquid are separated more rapidly.

A need exists for a system for separating a solid-liquid mixture having a controllable distribution system, oriented and configured to selectively provide the solid-liquid mixture to multiple discrete areas of a filtering vessel to promote uniform distribution and efficient filtration of the mixture.

A further need exists for a system for separating a solid-liquid mixture that enables observation of the separation process, as well as the condition and flow rate of water, polymer, and/or solid-liquid, so that the flow rate and distribution of the solid-liquid mixture within the container can be selectively modified based on the observation of the process.

A need also exists for a system for separating a solid-liquid mixture having one or more portholes, transparent mixers and tubes, or similar transparent and/or openable portions to enable monitoring of the mixtures and separation process and responsive control of the flow and distribution of the materials responsive to the monitoring.

Additionally, a need exists for an apparatus and system for separating a solid-liquid mixture that is portable, able to be transported to a variety of locations to receive and separate solid-liquid mixtures, and able to transport the separated components to a variety of disposal and/or treatment sites.

The present invention meets these needs.

### SUMMARY

An embodiment of the present invention relates to a system for separating liquids from solids. One or more tanks, or other sources containing a polymer solution are used to provide a mixture of one or more polymers and water, for flocculating a solid-liquid mixture. A number of polymers, known in the art, typically negatively charged polymers, are usable to flocculate a sludge or other solid-liquid mixture. Implementation of the present system can include testing a plurality of polymers against the solid-liquid mixture to be separated to determine which polymer or combination of polymers will provide the maximum effectiveness.

The polymer solution can transported and utilized on site, however in an embodiment of the invention, the solution can be formed on site by mixing one or more selected polymers with water from one or more public or private water sources, on site. The system can include one or more mixers, which in a preferred embodiment of the invention can include transparent sections of hose, tubing, and/or piping having one or more flow disruptors within. The disruption of flow causes the water and polymer to mix to form the solution, while the transparency of the mixers enables an operator to readily view the flow rate and/or condition of the polymer solution and directly or remotely adjust the flow of the polymer and/or the water responsive to the visual monitoring of the mixers. Any number of pumps, motors, and/or control valves can be directly or remotely actuated to control the flow of water, polymer, and/or polymer solution. Additionally, any number of inline flowmeters or other flowmeters can be used to monitor the flow rate of the polymer, the water, and/or the polymer solution.

The polymer solution source is placed in communication with one or more sources of sludge or a similar solid-liquid mixture, such that the combination and mixing of the polymer solution and the solid-liquid mixture flocculates the solid-liquid mixture to facilitate separation thereof. One or more mixers, motors, pumps, valves, or similar devices can be used to transport and combine the solid-liquid mixture and the polymer solution to promote flocculation.

The flocculated solid-liquid mixture is then flowed to a separation apparatus used to filter the mixture, separating the liquid and solid components. In an embodiment of the invention, one or more transparent sections of tube, pipe, and/or hose can be disposed between the polymer solution source, the solid-liquid mixture source, and the separation apparatus to enable visualization of the condition and flow rate of the flocculated solid-liquid mixture. Flow rates of the polymer solution and the solid-liquid mixture can be adjusted accordingly, responsive to the visual monitoring. Additionally, the flow rate of the flocculated solid-liquid mixture into the separation apparatus can also be monitored and controlled accordingly. As described previously, any number of pumps, motors, and/or control valves can be directly or remotely actuated to control the flow of the polymer solution, the solid-liquid mixture, and/or the flocculated solid-liquid mixture, and any number of inline flowmeters or other flowmeters can be used to monitor the flow rate of any of the materials.

Embodiments of the present invention also relate to a separation apparatus usable for separating the solid-liquid mixture, removing liquid components from solid components. The apparatus includes a tank having a floor and at least one exterior wall, defining a cavity for receiving the solid-liquid mixture. The tank can have any dimensions and any shape, depending on the quantity of material to be separated, the size and shape of the space available to accommodate the tank or any vehicles available to transport the tank, or other similar factors or considerations. Embodiments of the system can include simultaneous or sequential use of multiple separation apparatuses, when necessary.

In a preferred embodiment of the invention, the tank can have one or more interior walls, which can divide the tank into multiple cavities, providing an increased surface area for separation of a solid-liquid mixture, thereby improving the efficiency of the separation process.

A liquid-permeable filtration member is disposed over the floor, the exterior walls, the interior walls, if present, or combinations thereof, for retaining solid media in the cavity while permitting liquid from the solid-liquid mixture to pass through the filtration member. In an embodiment of the invention, the separated liquid can pass into an interior cavity beneath the filtration member for later collection or disposal. Any liquid-permeable filtration medium can be used, depending on the nature of the solid-liquid mixture to be separated. Usable filtration members can include a monofilament modified satin weave polyester filter material, having a 390 CFM, tensile strength ranging from 500 LB/In to 1820 LB/IN, and a particle retention of 330 microns. An interior space can exist between the filtration member and the exterior walls and/or the floor, usable to retain separated liquid.

The floor, exterior walls, and/or interior walls can include a support structure, which in an embodiment of the invention, can include a structure formed from expanded and/or perforated metal members having a significant amount of pore space to expedite the filtration process. Use of a support structure can enable the filtration member to withstand a greater weight of sludge in the tank and can define the interior space between the support structure and the exterior walls of the tank to collect the separated liquid.

An outlet can be in communication with the interior space for removing the liquid from the tank. The interior space between the filtration member and the exterior walls and/or floor of the tank can further contain one or more pipes, nozzles, or similar devices to spray water, or another liquid, toward the interior of the tank, to facilitate cleaning of the filtration media after use and emptying of the tank by loosening and washing away dried solid material.

The separation apparatus can include a controllable distribution system, having multiple inlets oriented such that each inlet provides the solid-liquid mixture to a differing discrete area of the cavity. Each inlet can be individually actuated, to enable the solid-liquid mixture to be selectively distributed to differing areas of the cavity. Through use of the controllable distribution system, an even, controlled, and efficient separation can be achieved by avoiding an accumulation of excess material in one or more areas of the tank. Conventional filtration vessels often suffer from areas within the vessel, especially proximate to the vessel's center or proximate to the inlet for receiving sludge, that filter more slowly and tend to accumulate excess sludge in absence of a controlled distribution system for evenly administering the solid-liquid mixture.

In an embodiment of the invention, one or more interior walls, if present, and/or one or more exterior walls of the tank can have a support structure mounted thereon, such as a catwalk, platform, or similar structure able to support the weight of an individual, for enabling visual observation of the cavity from above. Control means for the inlets of the controllable distribution system can be accessible from the support structure, enabling one or more individuals to selectively control the provision of the solid-liquid mixture into various discrete areas of the cavity based on observation performed from the support structure. Additionally, transparent mixers and/or tubes, hoses, or pipes, flowmeters, and similar equipment can be visualized from the support structure, and remote modifications to the flow rate of water, polymer, polymer solution, solid-liquid mixture, and/or flocculated solid-liquid mixture can be made responsive to visual observations performed from the support structure.

In a further embodiment of the invention, one or more of the exterior walls of the tank can have one or more exterior openings, such as portholes, having a transparent cover for enabling visual observation of the cavity through the exterior wall. Exterior openings can be used to facilitate an immediate and efficient determination of the level of solid-liquid mixture in the tank by an observer at the side of the tank. Use of openings in the exterior wall can also be useful in instances when the depth of the solid-liquid mixture in the tank is unclear when viewed from above.

The covers of the openings can be openable, for permitting access to the cavity to facilitate the entry and use of various cleaning devices, usable to remove solid media from the tank after the filtration and/or disposal processes are complete.

The tank and associated contents and equipment, as well as hoses, mixers, and/or other system components, can be mounted on or otherwise engaged with a transportable member, such as a trailer or a vehicle, enabling the present system to be transported to a variety of sites for collecting and separating solid-liquid mixtures, and to a variety of disposal sites, as needed. In addition to providing the present system with transportability, use of a transportable member can provide the present system with a desirable amount of elevation, which can facilitate access to outlets for recovering liquid removed from the solid-liquid mixture or for cleaning the tank, and can facilitate attachments between the tank and various treatment and/or mixing tanks, sludge sources, or other similar equipment.

Embodiments of the present invention also relate to a method for separating liquids from solids that includes providing a filtration vessel having multiple discrete areas, providing a solid-liquid mixture to at least one of the discrete areas while visually observing the filtration vessel, then selectively providing the solid-liquid mixture to at least one other discrete area based on the observation. Filtration of the solid-liquid mixture is thereby performed with improved efficiency when compared to conventional separation methods by ensuring optimal distribution of the solid-liquid mixture within the filtration vessel throughout the filtration process.

The solid-liquid mixture can be treated prior to introduction to the filtration vessel, such as by mixing with one or more polymers to promote flocculation, for improving the efficacy of the filtration process. The method can further include testing a plurality of polymers on the solid-liquid mixture to determine an optimal polymer or combination of polymers, which can be used to form the polymer solution.

The separated liquid can be discarded, or collected for treatment, use, analysis, or combinations thereof. The method can then include cleaning the filtration vessel and/or disposing of the remaining solid component. In an embodiment of the invention, cleaning of the remaining solid component can include providing water or another liquid to an interior space between a filtration member and the exterior walls of the filtration vessel.

### BRIEF DESCRIPTION OF THE DRAWINGS

In the detailed description of the embodiments of the invention presented below, reference is made to the accompanying drawings, in which:

FIG. 1 depicts a perspective view of an embodiment of a separation apparatus of the present invention.

FIG. 2 depicts the separation apparatus of FIG. 1 during use.

FIG. 3 depicts an embodiment of the separation apparatus engaged with a transportable member.

FIG. 4 depicts an embodiment of the present system.

Embodiments of the present invention are detailed below with reference to the listed Figures.

### DETAILED DESCRIPTION OF THE EMBODIMENTS

Before explaining the described and depicted embodiments of the invention in detail, it is to be understood that the present invention is not limited to the particular embodiments described and depicted and that the present invention can be practiced or carried out in various ways.

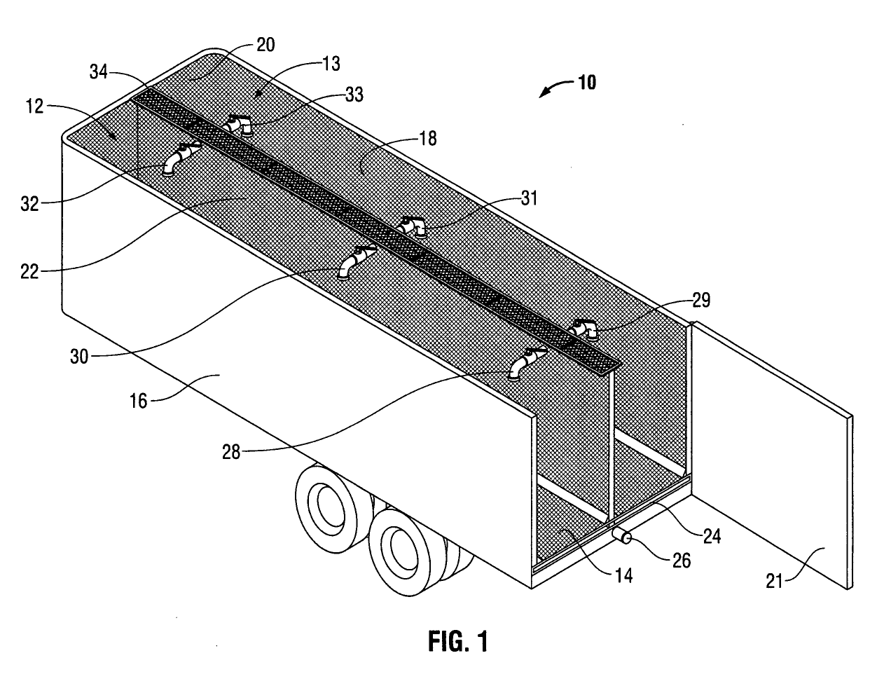

Referring now to FIG. 1, an end view of the present separation apparatus is depicted.

The separation apparatus includes a tank (10), which is defined by a floor (14), a first exterior wall (16), a second exterior wall (18) parallel to the first exterior wall (16), a third exterior wall (20), and a fourth exterior wall (21) parallel to the third exterior wall (20). The fourth exterior wall (21) is depicted being openable via one or more hinges, or similar movable connectors, to facilitate disposal of material within the tank (10) and to facilitate access to the tank (10) for cleaning.

In an embodiment of the invention, any individual exterior wall or multiple exterior walls of the tank (10) can be hinged or otherwise movable to enable the one or more walls to be opened, facilitating dumping of the tank (10) for disposal of the separated solid media, and for facilitating access to the tank (10) for cleaning any remaining solid media after the disposal process.

While FIG. 1 depicts the tank (10) having a generally rectangular shape, the present apparatus can include one or more tanks of any shape or size, depending on the nature and quantity of material to be separated.

The tank (10) is also shown having an interior dividing wall (22) extending across the length of the tank (10), substantially parallel to the first and second exterior walls (16, 18). The interior dividing wall (22) divides the tank (10) to form two cavities: a first cavity (12) between the first exterior wall (16) and the interior dividing wall (22), and a second cavity (13) between the interior dividing wall (22) and the second exterior wall (18).

The floor (14), the first, second, and third exterior walls (16, 18, 20), and the interior dividing wall (22) are depicted as generally rigid frames of perforated metal having a liquid-permeable filtration media disposed thereon. In an embodiment, the fourth exterior wall (21) can also include a liquid-permeable filtration media. Depending on the requirements and nature of the separation operation, any or none of the exterior walls (16, 18, 20, 21) can have filtration media disposed thereon, or can lack filtration media.

While any liquid-permeable material having sufficient durability to withstand the weight of a solid-liquid mixture within the tank (10) can be used as a filtration member, in an embodiment of the invention, the filtration member can include a monofilament modified satin weave polyester filter material, having a 390 CFM, tensile strength ranging from 500 LB/In to 1820 LB/IN, and a particle retention of 330 microns.

The floor (14), any of the exterior walls (16, 18, 20, 21), and/or the interior dividing wall (22) can be formed from an expanded or perforated metal framework, having a porosity ranging from 50 percent to 86 percent, or more, providing sufficient support to the filtration member while enabling an optimal amount of liquid from a solid-liquid mixture to pass through both the filtration member and the support, facilitating rapid separation.

FIG. 1 also depicts a controllable distribution system for providing a solid-liquid mixture to the tank (10), having a first nozzle (28) oriented to provide solid-liquid mixture to the first cavity (12) proximate to the fourth exterior wall (21). A second nozzle (30) is oriented to provide solid-liquid mixture to the center of the first cavity (12). A third nozzle (32) is oriented to provide solid-liquid mixture to the first cavity (12) proximate to the third exterior wall (20).

A fourth nozzle (29), a fifth nozzle (31), and a sixth nozzle (33) are shown similarly oriented over the second cavity (13). The fourth nozzle (29) is oriented to provide solid-liquid mixture to an area of the second cavity (13) proximate to the fourth exterior wall (21), the fifth nozzle (31) is oriented to provide solid-liquid mixture to the center of the second cavity (13), and the sixth nozzle (33) is oriented to provide solid-liquid mixture to the second cavity (13) proximate to the third exterior wall (20).

Each nozzle (28, 30, 32, 29, 31, 33) can individually or simultaneously provide varying quantities of solid-liquid mixture to the tank (10) through use of a manually or remotely actuatable valve disposed thereon. Other control means are also usable, including any type of automatic, manual, and/or remotely operated valves and/or nozzles.

FIG. 1 depicts a support structure (34), which can include a catwalk or other similar means able to support the weight of one or more individuals, disposed on the top of the interior dividing wall (22). The tank (10) could also include support structures along the top of any of the exterior walls (16, 18, 20, 21). The control means for each of the nozzles (28, 30, 32, 29, 31, 33) is accessible from the support structure (34), thereby enabling one or more individuals to observe the separation process in the tank (10) from above and to control the distribution of solid-liquid mixture to selected areas of the cavities (12, 13) based on the observation.

In conventional filtration vessels, it is common for sludge to accumulate in one or more areas due to blockage of filters, the manner in which the sludge is provided into the vessel, the non-uniform dispersion of solid media within the sludge, the differing availability of filtration surfaces at certain locations in the vessel, and other similar factors. The depicted controllable distribution system facilitates a more efficient separation process by enabling compensation for these and similar difficulties.

As a solid-liquid mixture is filtered through the filtration media disposed on the floor (14) and the walls (16, 18, 20, 22), separated liquid passes into an interior space (24) defined by the tank (10) and the floor (14). An outlet (26) in communication with the interior space (24) can be used to remove separated liquid for disposal, collection, analysis, treatment, and/or use. The outlet can include one or more valves or other control members, threads or other members for engaging a hose or similar transport device, or similar features. In an embodiment, the interior space (24) can include one or more pipes, nozzles, or similar devices oriented for providing liquid to the filtration media of the floor (14) and walls (16, 18, 20, 22), for cleaning the filtration media of dried solid matter after separation of a solid-liquid mixture. One or more inlets for receiving water or another liquid can be in communication with the interior space (24) for this purpose, or the outlet (26) could be used as an inlet for providing the liquid.

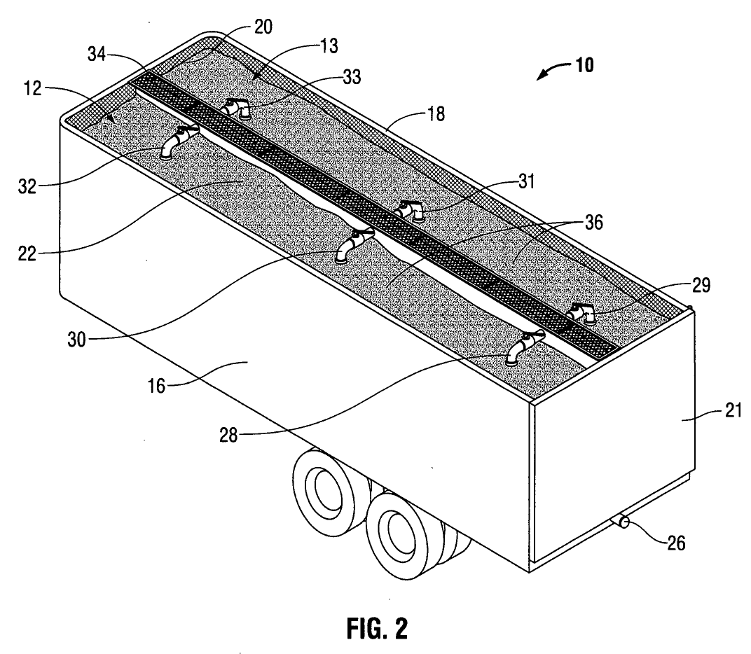

Referring now to FIG. 2, a perspective view of the tank (10) is shown from above. The tank (10) is shown having the first cavity (12) defined by the first exterior wall (16), the third exterior wall (20), the interior dividing wall (22), and the fourth exterior wall (21). The tank (10) is further shown having the second cavity (13) defined by the interior dividing wall (22), the third exterior wall (20), the second exterior wall (18), and the fourth exterior wall (21).

Each cavity (12, 13) is shown filled with a solid-liquid mixture (36). The first nozzle (28), second nozzle (30), and third nozzle (32) of the controllable distribution system are shown oriented over the first cavity (12), such that the first nozzle (28) can provide the solid-liquid mixture to an area of the first cavity (12) proximate to the fourth exterior wall (21), the second nozzle (30) can provide the solid liquid-mixture to the center of the first cavity (12), and the third nozzle (32) can provide the solid-liquid mixture to the first cavity (12) proximate to the third exterior wall (20).

FIG. 2 also depicts the fourth nozzle (29), fifth nozzle (31), and sixth nozzle (33), similarly oriented over the second cavity (13). The fourth nozzle (29) is oriented to provide the solid-liquid mixture to an area of the second cavity (13) proximate to the fourth exterior wall (21), the fifth nozzle (31) is oriented to provide the solid-liquid mixture to the center of the second cavity (13), and the sixth nozzle (33) is oriented to provide the solid-liquid mixture to the second cavity (13) proximate to the third exterior wall (20).

Each of the nozzles (28, 30, 32, 29, 31, 33) can be in communication with one or more pipes, tubes, hoses, or other similar conduits, in communication with a source containing the solid-liquid mixture, and, in an embodiment, one or more pumps for flowing the solid-liquid mixture. In an embodiment, one or more pipes or other conduits can be contained within the interior dividing wall (22), or one of the other walls (16, 18, 20, 21) for flowing solid-liquid mixture to the nozzles.

Each nozzle (28, 30, 32, 29, 31, 33) is shown having a manually actuatable valve for enabling selected nozzles to be individually or simultaneously actuated, based on observations of the level of the solid-liquid mixture (36) and the separation process. Observations can be performed from the support structure (34) disposed on the top of the interior dividing wall (22). The control members for each of the nozzles (28, 30, 32, 29, 31, 33) is directly or remotely accessible from the support structure (34), enabling a single individual to control the distribution of solid-liquid mixture in the tank (10) and facilitate rapid separation process.

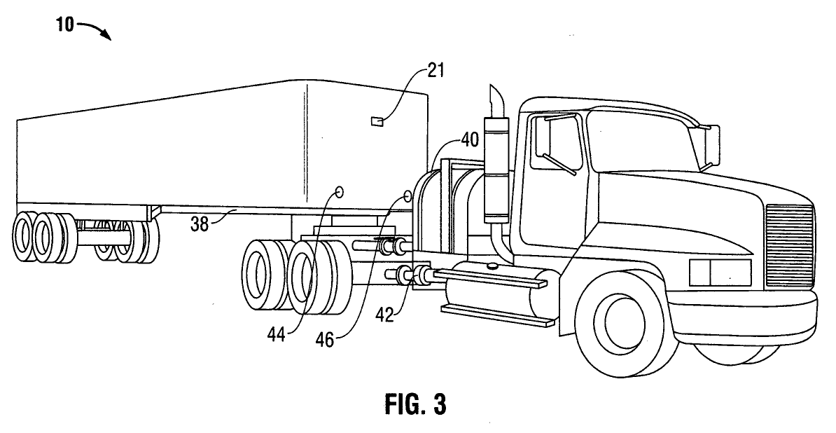

Referring now to FIG. 3, the tank (10) is shown disposed on a transportable member (38), depicted as a trailer, engaged with a truck (42). An additional tank (40) is shown disposed on the truck (42). The additional tank (40) can be used as a mixing tank for mixing a solid-liquid mixture with a polymer for causing flocculation, or for pre-treating the solid-liquid mixture. The additional tank (40) can also be used as a liquid tank for collecting separated liquid from the tank (10), or as a cleaning tank for providing water or another cleaning fluid to the tank (10) or to an interior space between the filtration member and the exterior walls of the tank (10) to remove dried solid matter from the filtration media.

The fourth exterior wall (21) of the tank (10) is shown having a first porthole (44) and a second porthole (46) disposed therethrough, for enabling monitoring of the separation process and the level of the solid-liquid mixture from the side of the tank (10), and for enabling the provision of cleaning materials and/or equipment into the tank (10) after the separation and/or disposal processes are complete.

In an embodiment, the transportable member (38), the tank (10), or combinations thereof, can include one or more mechanical lifting members for enabling an end of the tank (10) to be raised to facilitate dumping and/or disposal of separated solid media, and to facilitate cleaning of the tank (10) after the disposal process.

The height provided to the tank (10) by the transportable member (38) facilitates access to inlets and outlets of the tank (10), streamlining the installation and disassembly of the present system. The truck (42) and transportable member (38) enable the tank (10), the additional tank (40), and other similar equipment to be moved between source sites to obtain one or more solid-liquid mixtures, and between one or more disposal sites, while enabling the separation process to be performed at any location, including while in transit.

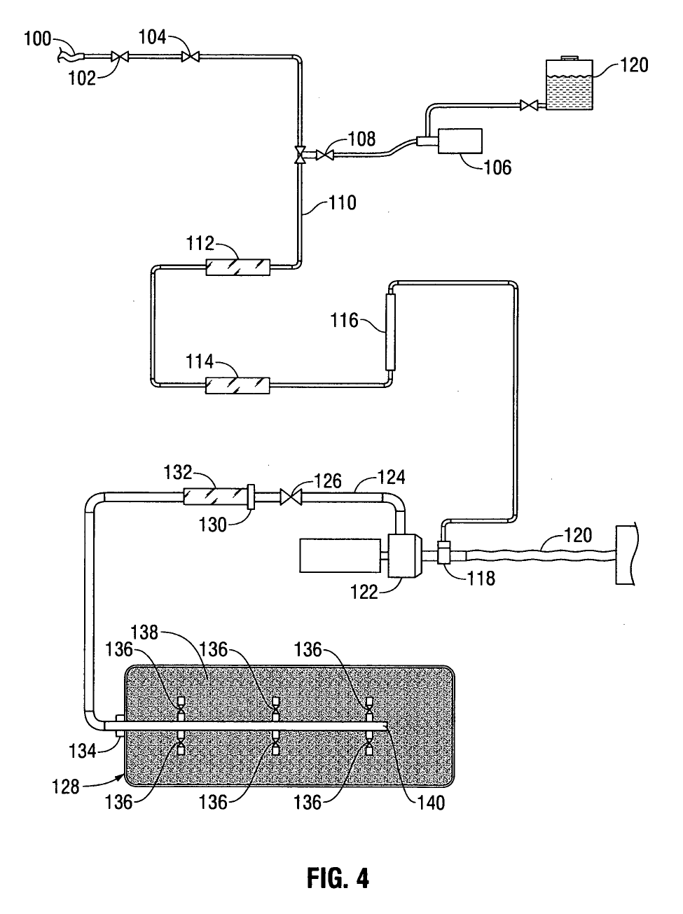

Referring now to FIG. 4, a diagram of an embodiment of the present system is shown, incorporating use of the described and depicted separation apparatus.

A water source (100) is depicted for providing water to the system, to form a usable polymer solution for flocculating the solid-liquid mixture. The water source (100) is depicted as a hose, which can be in communication with one or more public or private water sources, tanks, pools, lakes, reservoirs, or other usable sources of generally clean, fresh water. In areas where a readily accessible public or private water source is not available, the water source (100) can include one or more portable tanks or other vessels containing usable water.

FIG. 4 also depicts a polymer source (102), which is depicted as a tank containing one or more polymers specifically selected to provide optimal flocculation of a solid-liquid mixture. Usable materials typically include one or more negatively charged polymers, which can be tested with a small quantity of a solid-liquid mixture to determine a polymer or combination of polymers that will provide maximum effectiveness.

Water is provided from the water source (100) through one or more valves (104), which can include manually actuatable valves, remotely actuatable valves, automatic valves, or combinations thereof. Polymer is provided from the polymer source (102) to a one-way check valve (108), assisted by a polymer pump (106), which can include an electrical, motorized pump having a built-in flow meter. The water and polymer mix in the polymer solution line (110). The resulting polymer solution is passed through a first static mixer (112), which FIG. 4 depicts as a transparent section of tube containing a plurality of flow disruptors, which agitate and mix the water and polymer as the solution passes through. The solution is further passed through a second static mixer (114), of similar construction to the first static mixture (112). The first static mixer (112) is shown having a larger diameter than the second static mixer (114), which promotes a more effective blending of the water with the polymer. Use of transparent mixers enables the condition and flow rate of the contents to be visualized from a remote location, such as from the support structure of an adjacent separation apparatus, enabling an operator to adjust the flow of water, polymer, or the combined polymer solution, directly or remotely, responsive to the viewed contents of the mixers.

While FIG. 4 depicts transparent, static mixers used to mix the water and polymer, it should be noted that any number and any type of mixers can be used, or in an embodiment of the invention, the flow of water and polymer through the lines can sufficiently mix the water and polymer without requiring use of mixers.

After passing through the mixers (112, 114), the mixed polymer solution is flowed through an inline flowmeter (116), which measures the flow rate of the polymer solution. Other types of flowmeters are also usable. In an embodiment of the invention, the flowmeter (116) can produce a measurement visible from a remote location, such as from the support structure of an adjacent separation apparatus, enabling an operator to adjust the flow of water, polymer, or the combined polymer solution, directly or remotely, responsive to the measurement.

The polymer solution line (110) flows the mixed polymer solution to a sludge pump suction line (118), where the polymer solution is injected for mixing with a solid-liquid mixture. A solid-liquid mixture source (120), such as a waste treatment facility, is shown in fluid communication with the sludge pump suction line (118), for flowing a sludge or another solid-liquid mixture to a sludge pump (122) via the sludge pump suction line (118). As the polymer solution and the solid-liquid mixture are flowed together into the sludge pump suction line (118), the components mix and react, thereby flocculating the solid-liquid mixture. Passage of the mixture through the sludge pump (122) further mixes and flocculates the solid-liquid mixture.

The sludge pump (122) can include a motorized, electrical, variable speed pump, which can be directly controllable, or remotely controllable responsive to the flow rate and the condition of the flocculated solid-liquid mixture, the polymer, the water, the solid-liquid mixture from the source (120), or combinations thereof. The sludge pump (122) draws flocculated solid-liquid mixture from the suction line (118) and flows the flocculated mixture through a sludge line (124), which in an embodiment of the invention can include a line having a diameter of four inches, past a sludge meter (126), which measures the gallons per minute of flocculated solid-liquid mixture flowed to a separation apparatus (128). While FIG. 4 depicts the sludge meter (126) separated from the sludge pump (122) by a four-inch diameter sludge line (124), in an embodiment, the flocculated solid-liquid mixture can be flowed through a metering pump, which simultaneously pumps the mixture while measuring the flow rate.

The pumped solid-liquid mixture is flowed through a valve (130), such as a wafer valve, where the mixture passes through a clear section of tube (132). The transparent section of tube (132) enables the condition and flow rate of the flocculated solid-liquid mixture to be remotely visualized, such as when standing on a support structure of the separation apparatus (128), enabling the flow rate of the flocculated-solid liquid mixture and/or other components to be directly or remotely modified responsive to the visual observations of the mixture through the transparent section of tube (132).

The flocculated solid-liquid mixture is then flowed through an inlet (134) into the separation apparatus (128), which FIG. 4 depicts as a trailer, described previously. The separation apparatus (128) is shown having a plurality of nozzles (136) for distributing the flocculated solid-liquid mixture into discrete areas of a tank (138). A support structure (140), such as catwalk or similar structure able to support the weight of one or more individuals, extends across the top of the separation apparatus (128). An individual standing on the support structure (140) can readily view the contents of the transparent static mixers (112, 114), the measurements of the inline flowmeter (116) and the sludge meter (126), the contents passing through the clear section of tube (132), and the filtration process of the solid-liquid mixture within the tank (138). The individual can then remotely modify the flow rates of the water, the polymer, the polymer solution, the solid-liquid mixture, and/or the flocculated solid-liquid mixture responsive to observations made from atop the support structure (140). Further, the individual can directly or remotely modify the flow through each of the plurality of nozzles (136) to facilitate the filtration process based on observations of the tank (138) from above.

While various specific embodiments of the invention have been described with emphasis, it should be understood that within the scope of the appended claims, the present invention can be practiced other than as specifically described herein.

What is claimed is:

1. An apparatus for separating liquids from solids, the apparatus comprising:
a tank comprising a floor and at least one exterior wall defining a cavity for receiving a solid-liquid mixture;
a controllable distribution system comprising a plurality of inlets, wherein at least one of said inlets is oriented to provide the solid-liquid mixture to a first discrete area of the cavity, wherein at least one other of said inlets is oriented to provide the solid-liquid mixture to a second discrete area, and wherein each of said inlets is individually actuatable; and
a liquid-permeable filtration member disposed over the floor, said at least one exterior wall, or combinations thereof, for retaining solid media within the cavity above the liquid-permeable filtration member while permitting liquid to pass therethrough, wherein the liquid-permeable filtration member and the floor, said at least one exterior wall, or combinations thereof, define an interior space below the liquid-permeable filtration member for retaining the liquid.

2. The apparatus of claim 1, wherein the tank further comprises at least one interior wall having the liquid-permeable filtration member disposed thereon for increasing available surface area to separate the solid-liquid mixture.

3. The apparatus of claim 2, wherein said at least one interior wall comprises a support structure mounted thereon for enabling visual observation of the cavity from above.

4. The apparatus of claim 3, wherein each of said inlets is accessible from the support structure for enabling selective control of the provision of the solid-liquid mixture based on visual observation.

5. The apparatus of claim 1, further comprising at least one exterior opening disposed in said at least one exterior wall, wherein said at least one exterior opening comprises a transparent cover for enabling visual observation of the cavity through said at least one exterior wall.

6. The apparatus of claim 5, wherein the transparent cover is openable for permitting access by cleaning devices to clean or remove the solid media from the cavity.

7. The apparatus of claim 1, further comprising at least one outlet in communication with the interior space for removing the liquid.

8. The apparatus of claim 1, further comprising a transportable member on which the tank is mounted for enabling transport of the tank.

9. The apparatus of claim 1, wherein the interior space further comprises at least one apparatus for administering liquid to a back side of the liquid-permeable filtration member for cleaning the liquid-permeable filtration member of solid media.

10. A method for separating liquids from solids, the method comprising the steps of:
providing a filtration vessel comprising a plurality of discrete areas;
providing a solid-liquid mixture to at least one of said discrete areas while visually observing the filtration vessel and the solid-liquid mixture;
selectively providing the solid-liquid mixture to at least one other of said discrete areas based on the observation of the filtration vessel and the solid-liquid mixture; and
filtering the solid-liquid mixture to form separated liquid and separated solid.

11. The method of claim 10, further comprising the step of collecting the separated liquid for treatment, use, analysis, or combinations thereof.

12. The method of claim 10, further comprising the step of treating the solid-liquid mixture prior to introduction to the filtration vessel to facilitate filtering of the solid-liquid mixture.

13. The method of claim 12, wherein the step of treating the solid-liquid mixture comprises mixing the solid-liquid mixture with a polymer to cause flocculation.

14. An apparatus for separating liquids from solids, the apparatus comprising:
a tank comprising a floor, at least one exterior wall, and at least one interior dividing wall defining a plurality of cavities for receiving a solid-liquid mixture, wherein said at least one interior dividing wall comprises a support structure mounted thereon for enabling visual observation of the plurality of cavities from above; and
a liquid-permeable filtration member disposed over the floor, said at least one exterior wall, said at least one interior dividing wall, or combinations thereof, for retaining solid media within the plurality of cavities while permitting liquid to pass therethrough.

15. The apparatus of claim 14, further comprising a controllable distribution system comprising a plurality of inlets, wherein at least one of said inlets is oriented to provide the solid-liquid mixture to a first discrete area of the plurality of cavities, wherein at least one other of said inlets is oriented to provide the solid liquid mixture to a second discrete area of the plurality of cavities, wherein each of said inlets is individually actuatable, and wherein at least one of said inlets is accessible from the support structure for enabling selective control of the provision of the solid-liquid mixture based on visual observation.

16. The apparatus of claim 14, further comprising at least one exterior opening disposed in said at least one exterior wall, wherein said at least one exterior opening comprises a transparent cover for enabling visual observation of the plurality of cavities through said at least one exterior wall.

17. The apparatus of claim 16, wherein the transparent cover is openable for permitting access by cleaning devices to clean or remove the solid media from the plurality of cavities.

18. The apparatus of claim 14, wherein the liquid-permeable filtration member and the floor, said at least one exterior wall, said at least one interior dividing wall, or combinations thereof, define an interior space for retaining the liquid, and wherein the apparatus further comprises at least one outlet in communication with the interior space for removing the liquid.

19. The apparatus of claim 14, further comprising a transportable member on which the tank is mounted for enabling transport of the tank.

20. The apparatus of claim 18, wherein the interior space further comprises at least one apparatus for administering liquid to a back side of the liquid-permeable filtration member for cleaning the liquid-permeable filtration member of solid media.

21. An apparatus for separating liquids from solids, the apparatus comprising:
a tank comprising a floor, at least one exterior wall, and at least one interior dividing wall defining a plurality of cavities for receiving a solid-liquid mixture, wherein said at least one interior dividing wall comprises a support structure mounted thereon for enabling visual observation of the plurality of cavities from above;
a liquid-permeable filtration member disposed over the floor, said at least one exterior wall, and said at least one interior dividing wall for retaining solid media within the plurality of cavities while permitting liquid to pass therethrough, wherein the liquid-permeable filtration member and the floor, said at least one exterior wall, said at least one interior dividing wall, or combinations thereof, define an interior space for retaining the liquid;
a controllable distribution system comprising a plurality of inlets, wherein each of said inlets is oriented to provide the solid-liquid mixture to a discrete area of the plurality of cavities different from each other of said inlets, wherein each of said inlets is individually actuatable, and wherein each of said inlets is accessible from the support structure for enabling selective control of the provision of the solid-liquid mixture based on visual observation; and
at least one outlet in communication with the interior space for removing the liquid.

22. The apparatus of claim 21, further comprising at least one exterior opening disposed in said at least one exterior wall, wherein said at least one exterior opening comprises a transparent cover for enabling visual observation of the plurality of cavities through said at least one exterior wall.

23. The apparatus of claim 22, wherein the transparent cover is openable for permitting access by cleaning devices to clean or remove the solid media from the plurality of cavities.

24. The apparatus of claim 21, further comprising a transportable member on which the tank is mounted for enabling transport of the tank and facilitating access to said at least one outlet.

25. The apparatus of claim 21, wherein the interior space further comprises at least one apparatus for administering liquid to a back side of the liquid-permeable filtration member for cleaning the liquid-permeable filtration member of solid media.

26. A system for separating liquids from solids, the system comprising:
at least one solid-liquid mixture source for providing a solid-liquid mixture;
a mixer comprising an inlet and an outlet, wherein the inlet is in communication with said at least one solid-liquid mixture source for receiving and treating the solid-liquid mixture to cause flocculation;
at least one separation apparatus in communication with the outlet of mixer for receiving the solid-liquid mixture from the mixer and separating the solid-liquid mixture, said at least one separation apparatus comprising:
a tank comprising a floor and at least one exterior wall defining a cavity for receiving the solid-liquid mixture;
a liquid-permeable filtration member disposed over the floor, said at least one exterior wall, or combinations thereof, for retaining solid media within the cavity while permitting liquid to pass therethrough; and
a controllable distribution system comprising a plurality of inlets, wherein each of said inlets is oriented to provide the solid-liquid mixture to a discrete area of the cavity different from each other of said inlets, wherein each of said inlets is individually actuatable, and wherein the plurality of inlets is in communication with the outlet of the mixing tank for receiving the solid-liquid mixture and providing the solid-liquid mixture to the cavity for separation.

27. The system of claim 26, further comprising a transportable member on which the mixer, said at least one separation apparatus, or combinations thereof, is mounted for transport to solid-liquid mixture sources.

28. The system of claim 26, further comprising a liquid tank in communication with a liquid outlet of the tank for receiving the liquid.

29. The system of claim 26, wherein the mixing tank comprises at least one polymer for treating the solid-liquid mixture to cause flocculation.

30. A system for separating liquids from solids, the system comprising:
at least one polymer solution source for providing a mixture of a polymer and water;
at least one solid-liquid mixture source in communication with said at least one polymer solution source, wherein the mixture of the polymer and water causes flocculation of a solid-liquid mixture to promote separation of the solid-liquid mixture to form a flocculated solid-liquid mixture;
at least one separation apparatus in communication with said at least one polymer solution source and said at least one solid-liquid mixture source for receiving the flocculated solid-liquid mixture, said at least one separation apparatus comprising:
a tank comprising a floor and at least one exterior wall defining a cavity for receiving the flocculated solid-liquid mixture;
a liquid-permeable filtration member disposed over the floor, said at least one exterior wall, or combinations thereof, for retaining solid media within the cavity while permitting liquid to pass therethrough; and
a controllable distribution system comprising a plurality of inlets, wherein each of said inlets is oriented to provide the flocculated solid-liquid mixture to a discrete area of the cavity different from each other of said inlets, wherein each of said inlets is individually actuatable, and wherein the plurality of inlets is in communication with said at least one polymer solution source and said at least one solid-liquid mixture source for receiving the flocculated solid-liquid mixture and providing the flocculated solid-liquid mixture to the cavity for separation.

31. The system of claim 30, wherein said at least one polymer solution source comprises at least one water source in communication with at least one polymer source for providing water and the polymer, respectively, to form the mixture of the polymer and water, and wherein the system further comprises at least one mixer disposed between said at least one solid-liquid mixture source and said at least one polymer solution source for mixing the polymer and water.

32. The system of claim 31, wherein said at least one mixer comprises a transparent tube comprising at least one interior flow disruption for mixing water with the polymer while enabling visualization of the condition and flow rate of materials flowing through said at least one mixer.

33. The system of claim 30, wherein said at least one water source, said at least one polymer source, said at least one solid-liquid mixture source, or combinations thereof, comprise a control valve, and wherein the control valve is remotely actuatable responsive to the condition or flow rate of water, the polymer, the mixture of the polymer and water, the solid-liquid mixture, the flocculated solid-liquid mixture, or combinations thereof.

34. The system of claim 30, further comprising at least one inline flowmeter disposed between said at least one polymer solution source and said at least one solid-liquid mixture source, between said at least one separation apparatus and said sources, or combinations thereof.

35. The system of claim 30, further comprising at least one mixer disposed between said at least one separation apparatus and said sources for mixing the mixture of the polymer and water with the solid-liquid mixture to form the flocculated solid-liquid mixture.

36. The system of claim 35, wherein said at least one mixer comprises a motorized pump.

37. The system of claim 30, further comprising at least one transparent tube disposed between said at least one separation apparatus and said sources for enabling visualization of the condition and flow rate of the flocculated solid-liquid mixture.

38. A method for separating liquids from solids, the method comprising the steps of:
providing a polymer solution to a solid-liquid mixture to form a flocculated solid-liquid mixture;
providing a filtration vessel comprising a plurality of discrete areas;
providing a solid-liquid mixture to at least one of said discrete areas while visually observing the filtration vessel and the solid-liquid mixture;
selectively providing the solid-liquid mixture to at least one other of said discrete areas based on the observation of the filtration vessel and the solid-liquid mixture; and
filtering the solid-liquid mixture to form separated liquid and separated solid.

39. The method of claim 38, wherein the step of providing the polymer solution to the solid-liquid mixture comprises mixing water with at least one polymer to form the polymer solution.

40. The method of claim 38, further comprising the step of testing the solid-liquid mixture using a plurality of polymers to select an optimal polymer for use, wherein the polymer solution comprises the optimal polymer.

41. The method of claim 39, further comprising the step of visually monitoring a condition, a flow rate, or combinations thereof, of the polymer solution and controlling the flow of the water, said at least one polymer, or combinations thereof, responsive to the monitoring.

42. The method of claim 38, further comprising the step of visually monitoring a condition, a flow rate, or combinations thereof, of the flocculated solid-liquid mixture and controlling the flow of the flocculated solid-liquid mixture, the solid-liquid mixture, the polymer solution, or combinations thereof, responsive to the monitoring.
